(19) United States
(12) Patent Application Publication
(10) Pub. No.: US 2016/0255838 A1
(43) Pub. Date: Sep. 8, 2016

(54) METHOD FOR PREPARING ORGANIC COPPER COMPLEX OF ORGANIC COPPER ANTIBACTERIAL POLYAMIDE YARN

(71) Applicant: HARVEST SPF TEXTILE CO., LTD., Beijing (CN)

(72) Inventors: Dondgong Xu, Beijing (CN); Xiaohui Chen, Hebei (CN)

(73) Assignee: Harvest SPF Textile Co., Ltd., Beijing (CN)

(21) Appl. No.: 14/428,311

(22) PCT Filed: Mar. 31, 2014
(86) PCT No.: PCT/CN2014/076755

§ 371 Date: Mar. 13, 2015

(30) Foreign Application Priority Data
Mar. 31, 2014 (CN) 201410124110.9

(51) Int. Cl. A01N 55/02; D01F 6/90; D01F 1/10; A01N 25/10; D01D 1/02

(52) U.S. Cl. CPC A01N 55/02; A01N 25/10; D01D 1/02; D01F 1/103; D01F 6/90

(57) ABSTRACT

The invention discloses a method for preparing an organic copper complex of organic copper antibacterial polyamide yarn. The method for preparing the organic copper antibacterial polyamide yarn comprises the following steps: mixing urea, hexanolactam and acetamide according to a ratio of 1:(0.2-0.4):(0.2-0.4) in parts by weight to prepare a coordinated ionic liquid; adding sodium chlorate, potassium permanganate, sodium peroxide and copper powders according to a ratio of 1:(1-2):(1-2):(2.5-2.9) in parts by weight into 3-3.5 parts by weight of the coordinated ionic liquid to prepare the organic copper complex; slicing the organic copper complex and PA6 which are in a ratio of (80-86):(14-20) in parts by weight and putting them into a twin-screw extruder to prepare a spinning fusant, spinning, cooling and winding to form a cylinder. In the present invention, copper elements exist in fibers in an ionic state and form chemical chelation with fiber molecules, so that the organic copper complex is unlikely to fall off and has remarkable antibacterial functions. Furthermore, the addition amount of organic copper is reduced, the fiber color is lighter, which is beneficial to dyeing, therefore, the organic copper complex has broad market development prospect in the production field of textiles with health care functions.

### TECHNICAL FIELD

The present invention relates to a method for processing polyamide yarn, in particular to a method for preparing organic copper complex of organic copper antibacterial polyamide yarn.

### BACKGROUND

Before the microorganisms are realized, the citizens of the Roman Empire have found that it is very safe to drink water transported by copper tubes, and copper utensils and kitchenware can also prevent the spread of disease. After the discovery that the presence of microorganisms and bacteria would cause disease infection, scientists began to realize that the use of antibiotic properties of copper may prevent disease. Today, copper's antimicrobial properties have been extended to many fields such as fungicides, insecticides, anti-bacterial drugs, oral hygiene products and sanitation supplies medical equipment and preservatives.

Copper is a kind of nutrient, which is necessary for human body to maintain normal metabolism process along with amino acids, fatty acids and vitamins and so on, and plays a very important role in maintaining a healthy body, mainly in:

it can assist in the formation of hemoglobin and red blood cells, and for the synthesis of hemoglobin, myelin sheath, human melanin and collagen have obvious effect, and help to protect myelin sheath of peripheral nerve;

it is involved in the formation of human natural hair pigment, which is the key factor to give the skin, hair, and eye melanin staining, copper can generate melanocyte under the existence of tyrosinase to help prevent gray-haired;

it is actively involved in the production of elastic element in the connective tissue, and is the main component of the elastic fibers of the young skin and muscle of the whole body;

it is a strong oxidizer, the presence of these antioxidant enzyme and superoxide dismutase can protect cells from free radicals or inhibit the growth of bacteria strains, help to heal the wounds, and play an important role in the process of wound healing;

it is helpful for iron absorption of intestinal cells, released from main storage sites such as the liver; it is helpful for the utilization of sugar in the body; and it is helpful for bone formation and maintenance.

it is necessary for the production of RNA of new cell, if there is no copper element, the human body cannot produce new cells;

appropriate amount of copper element is helpful for the functioning of the brain.

However, the human body can't synthetize copper, so an amount of copper must be periodically provided by the human diet for the body to absorb. Therefore, in recent years, the functional health care products made of copper are developed rapidly, especially variety of fiber products having antibacterial function, such as polyamide fiber made of copper ions, acrylic fiber made of copper sulfide, vinylon made of copper ion, and polyester containing copper, etc.

The copper fibers circulated on the market are mostly produced by using inorganic copper, which having the following defects:

(1) the added amount of copper is high, and the manufacturing cost is high;

(2) the color of fiber product is dark green, and is not easily dyed;

(3) the inorganic copper distributed on the surface of the fiber can have antibacterial health care and other effects on human body, while the organic copper distributed in the fiber has fewer antibacterial health care effects on human body; and

(4) inorganic copper on the surface of the fiber is only embedded in the fiber, not combined with fiber through chemical bond, so it is easy to fall off in washing and use, resulting in reduced health care function.

### SUMMARY

The technical problems to be solved by the present invention are the manufacturing cost of antibacterial polyamide yarn produced from inorganic copper is high, the antibacterial polyamide yarn is not easily dyed and inorganic copper is easy to fall off.

In order to solve the above technical problems, the technical solution used in the present invention is to provide a method for preparing an organic copper complex of organic copper antibacterial polyamide yarn, which is characterized in that it comprises:

Step A10: preparing a coordinated ionic liquid;

mixing urea, hexanolactam and acetamide evenly according to a ratio of 1:(0.2-0.4):(0.2-0.4) in parts by weight, and then heating until hexanolactam and urea are both fully melted into liquid to obtain the coordinated ionic liquid; and

Step A20: preparing an organic copper complex;

taking sodium chlorate, potassium permanganate, sodium peroxide and copper powders according to parts by weight of 1:(1-2):(1-2):(2.5-2.9) to obtain a first component, adding the first component into 3-3.5 parts by weight of the coordinated ionic liquid, stirring evenly, the copper powders are fully oxidized to monovalent ions and form coordinated ions with the organic compound, cooled and then put them into pure water to obtain the organic copper complex.

In the method for preparing the organic copper complex, in step 10, heating temperature is 100-120° C., and the temperature is maintained for 0.5-1.0 hour, until the hexanolactam and urea are fully liquefied evenly.

In the method for preparing organic copper complex powder, no precipitation and color change occurred after the organic copper complex is left for 3-4 days.

The present invention further provides a method for manufacturing an organic copper antibacterial polyamide yarn comprising:

Step B10: preparing an organic copper complex by using the method;

Step B20: Slicing the organic copper complex and PA6 which are in a ratio of (80-86):(14-20) in parts by weight and putting them into a twin-screw extruder, mixing and melting to form a spinning fusant; and

Step B30: spinning the spinning fusant by a spinning jet, cooling and winding to form a cylinder.

In the method for manufacturing an organic copper antibacterial polyamide yarn, in Step B20, the temperature of each region of the twin-screw extruder is set to 260-273° C., the screw diameter of the twin-screw extruder is 67 mm, and a ratio of the screw length to the screw diameter is 36:1.

In the method for manufacturing an organic copper antibacterial polyamide yarn, in Step B30, the condition under which the spinning fusant is spinned into the organic copper antibacterial polyamide yarn is:

the temperature of spinning is 259-265° C., the pressure of the spinning jet is 15-16 MPa, lateral blowing speed is 40-42 m/min, lateral blowing temperature is 19-20° C., and lateral blowing humidity is 80-85%;

two oil injection nozzles are used to inject polyester oil, the distance between the spinning jet and the two oil injection nozzles is 1340-1360 mm, and the concentration of the oil is 10-12%;

the spinning tension is 12-18 cN, and spinning speed is 4000-4500 m/min; and

the content of copper element of the obtained organic copper antibacterial polyamide yarn is 0.98-2.60%.

In the method for manufacturing an organic copper antibacterial polyamide yarn, the PA6 is spinning PA6, and its relative viscosity is 2.5.

In the present invention, copper elements exist in fibers in an ionic state and have remarkable antibacterial functions. Furthermore, chemical chelation is formed between organic copper and fiber molecules, so that the organic copper on the surface of fiber is unlikely to fall off to ensure persistency of antibacterial and other functions of the fiber. Moreover, the added amount of organic copper is reduced, the fiber color is lighter, which is beneficial to dyeing, therefore, the organic copper has broad market development prospect in the production field of textiles with health care functions.

### DETAILED DESCRIPTION

Organic copper has more advantages than inorganic copper preparation, such as: organic copper is more safe and reliable than inorganic copper, and has good compatibility with the environment; has good affinity, can be mixed with most auxiliary agents without chemical reaction, has a broader range of applicability; can act in concert with a compound to achieve double sterilization effect, sterilization effect is more efficient. For this, the present invention provides a method for manufacturing an organic copper antibacterial polyamide yarn and a method for preparing an organic copper complex, the organic copper antibacterial polyamide yarn obtained by using the method of the present invention has remarkable and persistent antibacterial function, color of the fiber is lighter, is beneficial to dyeing, and has a broad market prospects for development of textiles having health care function. The present invention will be described below in detail combined with the specific embodiments.

The method for preparing an organic copper complex of organic copper antibacterial polyamide yarn provided by the present invention comprises:

Step A10: preparing a coordinated ionic liquid.

The required raw materials include urea (NH₂CONH₂), hexanolactam (NH(CH₂)₅CO) and acetamide in a ratio of 1:(0.2-0.4):(0.2-0.4) in parts by weight.

The method for preparing the coordinated ionic liquid comprises: first mixing urea (NH₂CONH₂), hexanolactam (NH(CH₂)₅CO) and acetamide evenly in a container, and then putting the container in a heating jacket, rising temperature to 100-120° C., and holding for 0.5-1.0 hour until solid hexanolactam and urea in the raw materials are both fully melted into uniform liquid to obtain the coordinated ionic liquid.

Step A20: preparing an organic copper complex.

The required raw materials include sodium chlorate, potassium permanganate, sodium peroxide and copper powders in a ratio of 1:(1-2):(1-2):(2.5-2.9) in parts by weight.

The method for preparing the organic copper complex comprises: taking sodium chlorate, potassium permanganate, sodium peroxide and copper powders to obtain a first component, adding the first component into 3-3.5 parts by weight of the coordinated ionic liquid (prepared in Step A10), as copper powders are fully oxidized to monovalent ions and form coordinated ions with the above organic compound, stirring for 5-8 mins, cooling to room temperature, forming a copper ion coordinated ionic liquid, and finally putting the copper ion coordinated ionic liquid into pure water, leaving for 3-4 days, no precipitation and color change occurred, and the organic copper complex is obtained.

The present invention further provides a method for manufacturing an organic copper antibacterial polyamide yarn comprising:

Step B10: preparing an organic copper complex by using the above method;

Step B20: Slicing the organic copper complex and PA6 which are in a ratio of (80-86):(14-20) in parts by weight and putting them into a twin-screw extruder, mixing and melting to form a spinning fusant; and

Step B30: spinning the spinning fusant by a spinning jet, cooling and winding to form a cylinder, thereby facilitating use, processing, transportation and storage.

In Step B20, the PA6 is spinning PA6, and its relative viscosity is 2.5 (produced by Yueyang petrochemical plant). The temperature of each region of the twin-screw extruder (produced by Nanjing rubber and plastic machinery plant) is set to 260-273° C., the screw diameter of the twin-screw extruder is 67 mm, and a ratio of screw length to screw diameter is 36:1.

The condition under which the spinning fusant is spinned into the organic copper antibacterial polyamide yarn is:

the temperature of spinning is 259-265° C., the pressure of the spinning jet is 15-16 MPa, lateral blowing speed is 40-42 m/min, lateral blowing temperature is 19-20° C., and lateral blowing humidity is 80-85%;

two oil injection nozzles are used to inject polyester oil (such as, F58.2POY oil produced by takemoto (Japan)), the distance between the spinning jet and the two oil injection nozzles is 1340-1360 mm, and the concentration of the oil is 10-12%;

the spinning tension is 12-18 cN, and spinning speed is 4000-4500 m/min; and

the content of copper element of the obtained organic copper antibacterial polyamide yarn is 0.98-2.60%.

During winding, winding head contact pressure is 120-140 N, winding angle is 7.2-7.8°, winding head model: SW461S600 (produced by Barmag (Germany)), and winding speed is 4000-4500 m/min.

Several specific embodiments and related performance test results are provided below.

### Embodiment 1

During the preparation of a coordinated ionic liquid, urea (NH₂CONH₂), hexanolactam (NH(CH₂)₅CO) and acetamide are in a ratio of 1:0.2:0.2 in parts by weight, heating temperature is 100° C., and holding time is half an hour.

During the preparation of the organic complex, sodium chlorate, potassium permanganate, sodium peroxide and copper powders are in a ratio of 1:1:1:2.5 in parts by weight, the parts by weight of the used coordinated ionic liquid is 3 parts.

During the preparation of spinning fusant, slices of the organic complex and PA6 are in a ratio of 80:20 in parts by weight, and the temperature of each region of the twin-screw extruder is set to 260° C.

During spinning, cooling and winding, spinning fusant is made by a spinning assembly into organic copper antibacterial polyamide yarn and cooled in the air, the temperature of spinning is 259° C., the pressure of the spinning jet is 15 MPa, lateral blowing speed is 40 m/min, lateral blowing temperature is 19° C., and lateral blowing humidity is 80%, the distance between the spinning jet and the oil injection nozzles is 1340 mm, F58.2POY oil is used, the concentration of the oil is 10%, the spinning tension is 12 cN, spinning speed is 4000 m/min, contact pressure of winding head is 120 N, winding angle is 7.2°, and winding speed is 4000 m/min.

### Embodiment 2

During the preparation of a coordinated ionic liquid, urea (NH₂CONH₂), hexanolactam (NH(CH₂)₅CO) and acetamide are in a ratio of 1:0.3:0.3 in parts by weight, heating temperature is 110° C., and holding time is 0.75 hours.

During the preparation of the organic complex, sodium chlorate, potassium permanganate, sodium peroxide and copper powders are in a ratio of 1:1.5:1.5:2.7 in parts by weight, the parts by weight of the used coordinated ionic liquid is 3.3 parts;

During the preparation of spinning fusant, slices of the organic complex and PA6 are in a ratio of 83:17 in parts by weight, and the temperature of each region of the twin-screw extruder is set to 267° C.

During spinning, cooling and winding, spinning fusant is made by a spinning assembly into organic copper antibacterial polyamide yarn and cooled in the air, the temperature of spinning is 262° C., the pressure of the spinning jet is 15.5 MPa, lateral blowing speed is 41 m/min, lateral blowing temperature is 19.5° C., lateral blowing humidity is 83%, the distance between the spinning jet and the oil injection nozzles is 1350 mm, F58.2POY oil is used, the concentration of the oil is 11%, the spinning tension is 15 cN, spinning speed is 4300 m/min, contact pressure of winding head is 130 N, winding angle is 7.4°, and winding speed is 4300 m/min.

### Embodiment 3

During the preparation of a coordinated ionic liquid, urea (NH₂CONH₂), hexanolactam (NH(CH₂)₅CO) and acetamide are in a ratio of 1:0.4:0.4 in parts by weight, heating temperature is 120° C., and holding time is 1.0 hour.

During the preparation of the organic complex, sodium chlorate, potassium permanganate, sodium peroxide and copper powders are in a ratio of 1:2.0:2.0:2.9 in parts by weight, the parts by weight of the used coordinated ionic liquid is 3.5 parts.

During the preparation of spinning fusant, slices of the organic complex and PA6 are in a ratio of 86:14 in parts by weight, and the temperature of each region of the twin-screw extruder is set to 273° C.

During spinning, cooling and winding, spinning fusant is made by a spinning assembly into organic copper antibacterial polyamide yarn and cooled in the air, the temperature of spinning is 265° C., the pressure of the spinning jet is 16 MPa, lateral blowing speed is 42 m/min, lateral blowing temperature is 20° C., lateral blowing humidity is 85%, the distance between the spinning jet and the oil injection nozzles is 1360 mm, F58.2POY oil is used, the concentration of the oil is 12%, the spinning tension is 18 cN, spinning speed is 4500 m/min, contact pressure of winding head is 140 N, winding angle is 7.8°, and winding speed is 4500 m/min.

The performances of the three kinds of organic copper antibacterial polyamide yarn products after 50 times of washing are shown in the following table.

| | bacteriostasis rate to | bacteriostasis rate to | copper |
|---|---|---|---|
| | staphylococcus | pneumoniae | content |
| | aureus % | bacterium % | loss % |
| Embodiment 1 | ≧99 | ≧99 | <0.1 |
| Embodiment 2 | ≧99 | ≧99 | <0.1 |
| Embodiment 3 | ≧99 | ≧99 | <0.1 |

The present invention is not limited to the preferred embodiments, anyone will know the structural changes made according to the teachings of the present invention, all the same or similar technical solutions as the present invention fall into the scope of the present invention.

1. A method for preparing an organic copper complex of organic copper antibacterial polyamide yarn, which is characterized in that it comprises:
Step A10: preparing a coordinated ionic liquid;
mixing urea, hexanolactam and acetamide evenly according to a ratio of 1:(0.2-0.4):(0.2-0.4) in parts by weight, and then heating until hexanolactam and urea are both fully melted into liquid to obtain the coordinated ionic liquid; and
Step A20: preparing an organic copper complex;
taking sodium chlorate, potassium permanganate, sodium peroxide and copper powders according to a ratio of 1:(1-2):(1-2):(2.5-2.9) in parts by weight to obtain a first component, adding the first component into 3-3.5 parts by weight of the coordinated ionic liquid, stirring evenly, the copper powders are fully oxidized to monovalent ions and form coordinated ions with the organic compound, cooled and then put them into pure water to obtain the organic copper complex.

2. The method for preparing organic copper complex according to claim 1, it is characterized in that, in step 10, heating temperature is 100-120° C., and the temperature is maintained for 0.5-1.0 hour, until the hexanolactam and urea are fully liquefied evenly.

3. The method for preparing organic copper complex according to claim 1, it is characterized in that, no precipitation and color change occurred after the organic copper complex was left for 3-4 days.

4. A method for manufacturing an organic copper antibacterial polyamide yarn, which is characterized in that it comprises:
Step B10: preparing an organic copper complex by using the method according to claim 1;
Step B20: Slicing the organic copper complex and PA6 which are in a ratio of (80-86):(14-20) in parts by weight and putting them into a twin-screw extruder, mixing and melting to form a spinning fusant; and
Step B30: spinning the spinning fusant by a spinning jet, cooling and winding to form a cylinder.

5. The method for manufacturing an organic copper antibacterial polyamide yarn according to claim 4, it is characterized in that, in Step B20, the temperature of each region of the twin-screw extruder is set to 260-273° C., the screw diameter of the twin-screw extruder is 67 mm, and a ratio of screw length to screw diameter is 36:1.

6. The method for manufacturing an organic copper antibacterial polyamide yarn according to claim 5, it is characterized in that, in Step B30, the condition under which the spinning fusant is spinned into the organic copper antibacterial polyamide yarn is:
the temperature of spinning is 259-265° C., the pressure of the spinning jet is 15-16 MPa, lateral blowing speed is 40-42 m/min, lateral blowing temperature is 19-20° C., and lateral blowing humidity is 80-85%;
two oil injection nozzles are used to inject polyester oil, the distance between the spinning jet and the two oil injection nozzles is 1340-1360 mm, and the concentration of the oil is 10-12%;
the spinning tension is 12-18 cN, and spinning speed is 4000-4500 m/min; and the content of copper element of the obtained organic copper antibacterial polyamide yarn is 0.98-2.60%.

7. The method for manufacturing an organic copper antibacterial polyamide yarn according to claim 4, it is characterized in that, the PA6 is spinning PA6, and its relative viscosity is 2.5.
